(19) United States
(12) Patent Application Publication
(10) Pub. No.: US 2026/0196431 A1
(43) Pub. Date: Jul. 9, 2026

(54) ELECTROMAGNETIC RELAY

(71) Applicant: OMRON Corporation, Kyoto-shi, Kyoto (JP)

(72) Inventors: Takeshi NISHIDA, Kyoto-shi, Kyoto (JP); Ayaka MIYAKE, Kyoto-shi, Kyoto (JP)

(21) Appl. No.: 19/134,213

(22) PCT Filed: Nov. 20, 2023
(86) PCT No.: PCT/JP2023/041588

§ 371 Date: May 30, 2025

(30) Foreign Application Priority Data
Dec. 6, 2022 (JP) 2022-195084

(51) Int. Cl. H01H 50/54

(52) U.S. Cl. CPC H01H 50/54

(57) ABSTRACT

An electromagnetic relay includes a drive device and a contact device including plural contact sets. Each set comprises a first fixed terminal including a first fixed contact, a second fixed terminal including a second fixed contact spaced apart from the first fixed contact in a first direction, and a movable contact piece including a first movable contact and a second movable contact. The drive device moves the movable contact piece. The first fixed terminal includes a first conductive portion, a second conductive portion, and third conductive portion. The first conductive portion includes the first fixed contact. The second conductive portion is connected to the first conductive portion and is arranged, at least partially, laterally relative to the movable contact piece in the first direction. The third conductive portion is connected to the second conductive portion and extends in a direction from the first movable contact toward the second movable contact.

### CROSS-REFERENCE TO RELATED APPLICATIONS

This application is the U.S. National Phase of International Application No. PCT/JP2023/041588, filed on Nov. 20, 2023. That application claims priority to Japanese Patent Application No. 2022-195084, filed Dec. 6, 2022. The contents of those two applications are incorporated by reference herein in their entireties.

### FIELD

The claimed invention relates to an electromagnetic relay.

### BACKGROUND

Japanese Patent Application Publication No. H06-012956 discloses an electromagnetic relay that includes a contact device having a plurality of contact sets, each set comprising a pair of fixed contacts and a movable contact piece including a pair of movable contacts, and a drive device configured to move the movable contact piece. The plurality of contact sets are arranged in the direction of movement of the movable contact piece relative to the base.

In equipment using an electromagnetic relay provided with a contact device including a plurality of contact sets, when a large current occurs due to a short circuit, the current flows through the contact device, thereby generating an electromagnetic repulsive force between the contacts, which may cause separation of the contacts. To decrease the separation of the contacts, for example, the electromagnetic force of the drive device may be increased. However, in this case, the drive device becomes larger, resulting in an increase in the overall size of the electromagnetic relay.

### SUMMARY

An object of the claimed invention is to decrease the separation between contacts due to electromagnetic repulsive force while restraining increase in the size of the electromagnetic relay, in an electromagnetic relay provided with a contact device including a plurality of contact sets, each set comprising a pair of fixed contacts and a movable contact piece including a pair of movable contacts.

An electromagnetic relay according to one embodiment of the claimed invention includes a contact device and a drive device. The contact device includes a plurality of contact sets, each of the plurality of contact sets comprising a first fixed terminal including a first fixed contact, a second fixed terminal including a second fixed contact, and a movable contact piece. The second fixed contact is spaced apart from the first fixed contact in a first direction. The movable contact piece includes a first movable contact facing the first fixed contact in a second direction orthogonal to the first direction and a second movable contact facing the second fixed contact in the second direction. The plurality of contact sets are arranged in the second direction. The drive device is configured to move the movable contact pieces of the respective contact sets in the second direction. The first fixed terminal includes a first conductive portion, a second conductive portion, and a third conductive portion. The first conductive portion includes the first fixed contact. The second conductive portion is connected to the first conductive portion and is arranged, at least in part, laterally relative to the movable contact piece in the first direction. The third conductive portion is connected to the second conductive portion and extends in a direction from the first movable contact toward the second movable contact.

In this electromagnetic relay, a magnetic field is generated by a current flowing through the second conductive portion of the first fixed terminal and acts on the current flowing through the movable contact piece. As a result, a first Lorentz force is generated. The first Lorentz force acts on the movable contact piece in a contact direction in which the first movable contact approaches the first fixed contact. Furthermore, a magnetic field is generated by a current flowing through the third conductive portion of the first fixed terminal and acts on the current flowing through the movable contact piece. As a result, a second Lorentz force is generated. The second Lorentz force also acts on the movable contact piece in the contact direction. Since the first Lorentz force and the second Lorentz force act in a direction opposite to the electromagnetic repulsive force generated between the first fixed terminal and the first movable contact, the electromagnetic repulsive force can be reduced. With this configuration, for example, compared to a case where the electromagnetic force of the drive device is increased to reduce the separation between contacts, an increase in the overall size of the electromagnetic relay can be restrained.

The electromagnetic relay may further include a base for positioning the first fixed terminal. The first fixed terminal may further include a fourth conductive portion. The fourth conductive portion may extend from the third conductive portion in a third direction orthogonal to both the first direction and the second direction and may protrude from the base in the third direction. In this case, the base can be used to position the first fixed terminal. Moreover, since the fourth conductive portion extends from the third conductive portion in the third direction and protrudes from the base, the electromagnetic relay in the second direction can be restrained from increasing in size.

The third conductive portion may overlap the first fixed contact when viewed from the second direction. In this case, the magnetic field generated by the current flowing through the third conductive portion acts effectively on the current flowing through the movable contact piece. As a result, the second Lorentz force increases.

The second conductive portion may overlap the center of the first movable contact in a state where the first movable contact is in contact with the first fixed contact. In this case, the magnetic field generated by the current flowing through the second conductive portion acts effectively on the current flowing through the movable contact piece. As a result, the first Lorentz force increases.

The electromagnetic relay may further include a first insulating wall disposed between the movable contact piece and the second conductive portion. In this case, the insulation performance between the movable contact piece and the second conductive portion is improved.

In a state where the first movable contact is separated from the first conductive portion, the distance between the movable contact piece and the second conductive portion may be smaller than the distance between the first movable contact and the first conductive portion. In this case, the first insulating wall ensures insulation between the movable contact piece and the second conductive portion, while restraining an increase in the size of the electromagnetic relay in the first direction.

The electromagnetic relay may further include a second insulating wall disposed between the movable contact piece and the third conductive portion. In this case, the insulation performance between the movable contact piece and the third conductive portion is improved.

In the state where the first movable contact is separated from the first conductive portion, the distance between the movable contact piece and the third conductive portion may be smaller than the distance between the first movable contact and the first conductive portion. In this case, the third insulating wall ensures insulation between the movable contact piece and the third conductive portion, while restraining an increase in the size of the electromagnetic relay in the second direction.

The second insulating wall may restrict the movement of the movable contact piece in the direction in which the first movable contact separates from the first fixed contact. In this case, the second insulating wall can also function as a stopper for restricting the movement of the movable contact piece.

The electromagnetic relay may further include a third insulating wall. The plurality of contact sets may include a first contact set and a second contact set adjacent to the first contact set. The third insulating wall may be disposed between the first conductive portion of the first fixed terminal of the first contact set and the third conductive portion of the first fixed terminal of the second contact set. In this case, the insulation performance between the first conductive portion of the first fixed terminal of the first contact set and the third conductive portion of the first fixed terminal of the second contact set is improved.

One of the first conductive portion of the first fixed terminal of the first contact set and the third insulating wall may include a first protrusion configured to abut the other of the first conductive portion of the first fixed terminal of the first contact set and the third insulating wall. In this case, the insulation performance between the first conductive portion of the first fixed terminal of the first contact set and the third conductive portion of the first fixed terminal of the second contact set is improved. Additionally, the first protrusion serves to position the first conductive portion.

One of the third conductive portion of the first fixed terminal of the second contact set and the third insulating wall may include a second protrusion configured to abut the other of the third conductive portion of the first fixed terminal of the second contact set and the third insulating wall. In this case, the insulation performance between the first conductive portion of the first fixed terminal of the first contact set and the third conductive portion of the first fixed terminal of the second contact set is improved. Additionally, the second protrusion serves to position the third conductive portion of the first fixed terminal of the second contact set.

When the first movable contact is separated from the first conductive portion, the distance between the movable contact piece and the second conductive portion may be greater than the distance between the first movable contact and the first conductive portion. Similarly, when the first movable contact is separated from the first conductive portion, the distance between the movable contact piece and the third conductive portion may be greater than the distance between the first movable contact and the first conductive portion. In this case, insulation between the movable contact piece and the second conductive portion and between the movable contact piece and the third conductive portion can be ensured.

The third conductive portion may not overlap the first fixed contact when viewed from the second direction. In this case, the first fixed contact can be easily caulked and fixed to the third conductive portion.

### BRIEF DESCRIPTION OF THE DRAWINGS

FIG. 1 is a perspective view of an electromagnetic relay.

FIG. 2 is a top view of a contact device.

FIG. 3 is another top view of a contact device.

FIG. 4 is a perspective view of a first contact set.

FIG. 5 is a top view of a first contact set.

FIG. 6 is a perspective view of a base.

FIG. 7 is a top view of a part of a contact device.

FIG. 8 is a diagram illustrating a modification of the first fixed terminal.

FIG. 9 is a top view of part of a first contact set according to a modification.

### DETAILED DESCRIPTION

Hereinafter, an embodiment of an electromagnetic relay 1 according to one aspect of the claimed invention will be described with reference to the drawings. In referring to the drawings, the direction indicated by X (an example of the second direction) will be referred to as the left-right direction, the direction indicated by Y (an example of the first direction) as the front-rear direction, and the direction indicated by Z (an example of the third direction) as the up-down direction. Further, the direction indicated by X1 will be referred to as the rightward direction, X2 as the leftward direction, Y1 as the forward direction, Y2 as the rearward direction, Z1 as the upward direction, and Z2 as the downward direction. These directions are defined for convenience of description, and do not limit the arrangement directions of the electromagnetic relay 1.

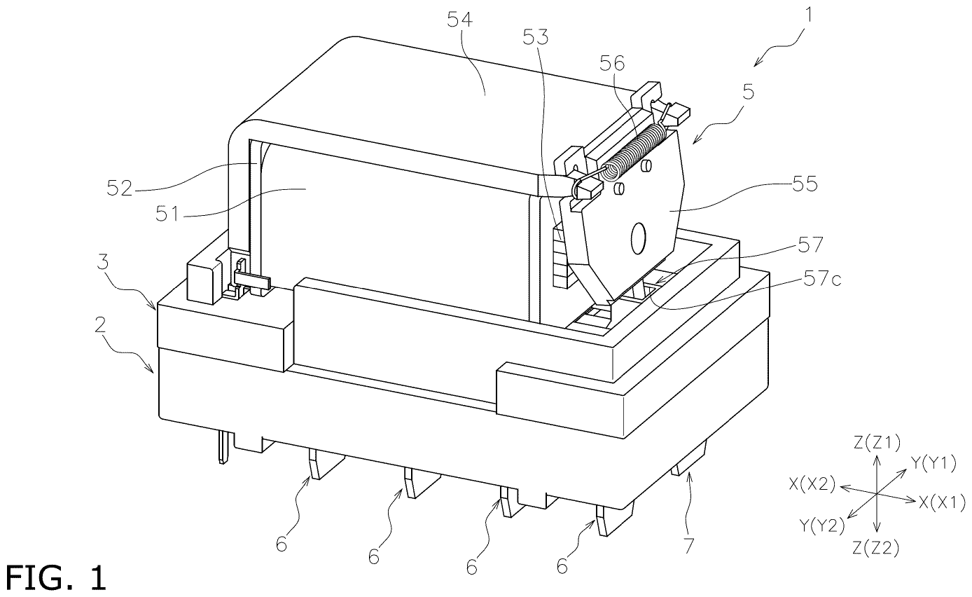

As illustrated in FIGS. 1 to 3, the electromagnetic relay 1 includes a base 2, a partition member 3, a contact device 4, and a drive device 5.

The base 2 and the partition member 3 are comprised of insulating material, such as resin. The base 2 extends in the left-right direction and the front-rear direction. The partition member 3 is disposed above the base 2. The partition member 3 is positioned between the contact device 4 and the drive device 5. In the electromagnetic relay 1, the partition member 3 separates the space in which the contact device 4 is located from the space in which the drive device 5 is located. The partition member 3 is covered by a case (not shown) from the above.

The contact device 4 is housed within the internal space defined by the base 2 and the partition member 3. The contact device 4 includes a plurality of contact sets 10, each set comprising a first fixed terminal 6, a second fixed terminal 7, a movable contact piece 8, and a contact spring 9. The plurality of contact sets 10 are arranged side by side in the left-right direction. The contact sets 10 are spaced apart from each other in the left-right direction.

In the present embodiment, the plurality of contact sets 10 includes four contact sets 10a to 10d. Specifically, the plurality of contact sets 10 includes a first contact set 10a, a second contact set 10b, a third contact set 10c, and a fourth contact set 10d. The first to fourth contact sets 10a to 10d are arranged from right to left in the order of the first contact set 10a to the fourth contact set 10d.

The first to fourth contact sets 10a to 10d are the same in configuration. That is, each of the first to fourth contact sets 10a to 10d includes a first fixed terminal 6, a second fixed terminal 7, a movable contact piece 8, and a contact spring 9. Here, among the plurality of contact sets 10, the details of the first fixed terminal 6, the second fixed terminal 7, the movable contact piece 8, and the contact spring 9 of the first contact set 10a will be described.

The first fixed terminal 6 is a plate terminal and is formed of electrically conductive material. The first fixed terminal 6 is supported by the base 2. For example, the first fixed terminal 6 is fixedly press-fitted to the base 2. The first fixed terminal 6 is situated rearward of the center of the movable contact piece 8 in the front-rear direction.

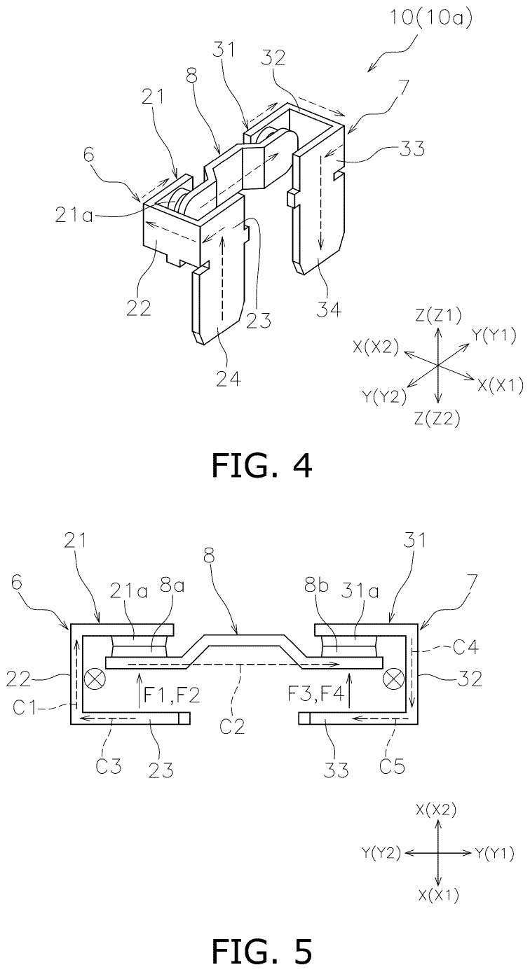

As illustrated in FIGS. 4 and 5, the first fixed terminal 6 includes a first conductive portion 21, a second conductive portion 22, a third conductive portion 23, and a fourth conductive portion 24. The first conductive portion 21 extends in a direction intersecting the left-right direction. The first conductive portion 21 is disposed to the left of the movable contact piece 8. The first conductive portion 21 includes a first fixed contact 21a. The first fixed contact 21a is disposed on the right surface of the first conductive portion 21. The first fixed contact 21a is fixed to the first conductive portion 21 by caulking. It should be noted that the first fixed contact 21a may alternatively be formed integrally with the first conductive portion 21.

The second conductive portion 22 extends in a direction intersecting the front-rear direction. The second conductive portion 22 is connected to the first conductive portion 21. At least part of the second conductive portion 22 is arranged laterally relative to the movable contact piece 8 in the front-rear direction. More specifically, at least part of the second conductive portion 22 is arranged laterally relative to the rear side of the movable contact piece 8. The second conductive portion 22 extends rightward from the rear end of the first conductive portion 21. The second conductive portion 22 is bent rightward from the rear end of the first conductive portion 21. When viewed from the front-rear direction, the second conductive portion 22 overlaps the first fixed contact 21a and the movable contact piece 8. In a state where the first movable contact 8a, described later, is in contact with the first fixed contact 21a, the second conductive portion 22 overlaps the center of the first movable contact 8a.

The third conductive portion 23 extends in a direction intersecting the left-right direction. The third conductive portion 23 is connected to the second conductive portion 22. The third conductive portion 23 extends in a direction from the first movable contact 8a toward the second movable contact 8b described below. The third conductive portion 23 extends forward from the right end of the second conductive portion 22. The third conductive portion 23 is bent forward from the right end of the second conductive portion 22. The third conductive portion 23 is disposed to the right of the movable contact piece 8. When viewed from the left-right direction, the third conductive portion 23 overlaps the first fixed contact 21a and the first movable contact 8a. The third conductive portion 23 extends in the front-rear direction beyond the first conductive portion 21.

The fourth conductive portion 24 extends in a direction intersecting the left-right direction. The fourth conductive portion 24 is connected to the third conductive portion 23. The fourth conductive portion 24 protrudes from the base 2 in the up-down direction. The fourth conductive portion 24 extends downward from the third conductive portion 23 and protrudes downward from the base 2. The fourth conductive portion 24 is configured to be connected to an external terminal (not shown), such as a bus bar.

The second fixed terminal 7 is a plate terminal and is formed of electrically conductive material. The second fixed terminal 7 is supported by the base 2. For example, the second fixed terminal 7 is fixedly press-fitted to the base 2. The second fixed terminal 7 is situated forward of the center of the movable contact piece 8 in the front-rear direction. The second fixed terminal 7 is spaced apart from the first fixed terminal 6 in the front-rear direction. The second fixed terminal 7 is situated forward of the first fixed terminal 6.

The second fixed terminal 7 is disposed symmetrically with respect to the first fixed terminal 6. The second fixed terminal 7 has a shape that is symmetrical with the first fixed terminal 6 in the front-rear direction. Therefore, a detailed description of the second fixed terminal 7 will be omitted.

The second fixed terminal 7 includes a first conductive portion 31, a second conductive portion 32, a third conductive portion 33, and a fourth conductive portion 34. The first conductive portion 31 is disposed to the left of the movable contact piece 8. The first conductive portion 31 includes a second fixed contact 31a. The second fixed contact 31a is disposed on the right surface of the first conductive portion 31.

The second conductive portion 32 extends rightward from the front end of the first conductive portion 31. At least part of the second conductive portion 32 is arranged laterally relative to the front side of the movable contact piece 8. When viewed from the front-rear direction, the second conductive portion 32 overlaps the second fixed contact 31a and the movable contact piece 8.

The third conductive portion 33 extends rearward from the right end of the second conductive portion 32. The third conductive portion 33 is disposed to the right of the movable contact piece 8. When viewed from the left-right direction, the third conductive portion 33 overlaps the second fixed contact 31a and the second movable contact 8b.

The fourth conductive portion 34 extends downward from the third conductive portion 33 and protrudes downward from the base 2. The fourth conductive portion 34 is configured to be connected to an external terminal (not shown), such as a bus bar.

The movable contact piece 8 is a plate terminal and is formed of electrically conductive material. The movable contact piece 8 extends in the front-rear direction. The movable contact strip 8 has a convex curved shape toward the left near the center in the front-back direction.

The movable contact piece 8 includes a first movable contact 8a and a second movable contact 8b. The first movable contact 8a and the second movable contact 8b are disposed on the left surface of the movable contact piece 8. The first movable contact 8a is arranged opposite the first fixed contact 21a in the left-right direction. The second movable contact 8b is arranged opposite the second fixed contact 31a in the left-right direction. The first movable contact 8a and the second movable contact 8b are fixed to the movable contact piece 8 by caulking. Alternatively, the first movable contact 8a and the second movable contact 8b may be formed integrally with the movable contact piece 8.

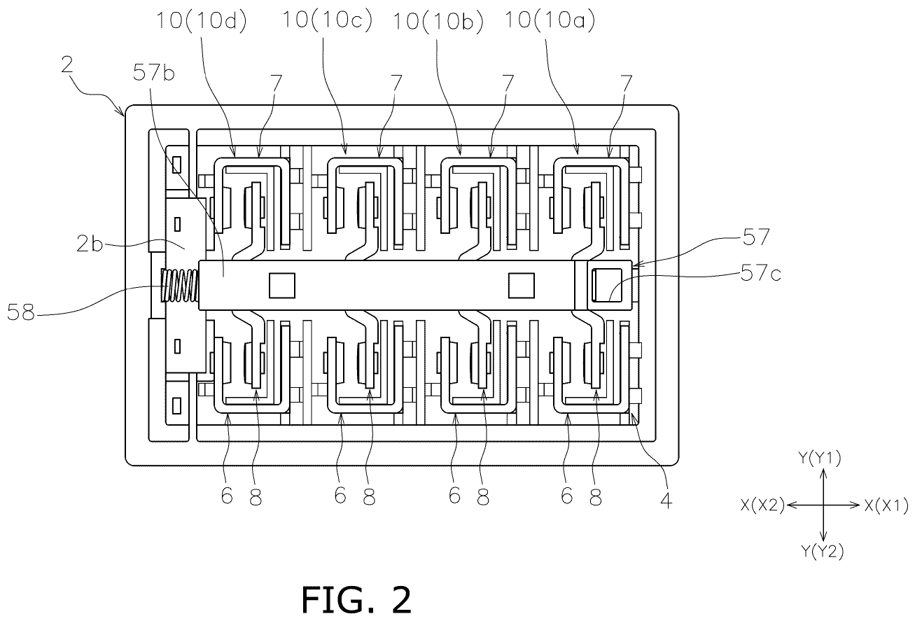

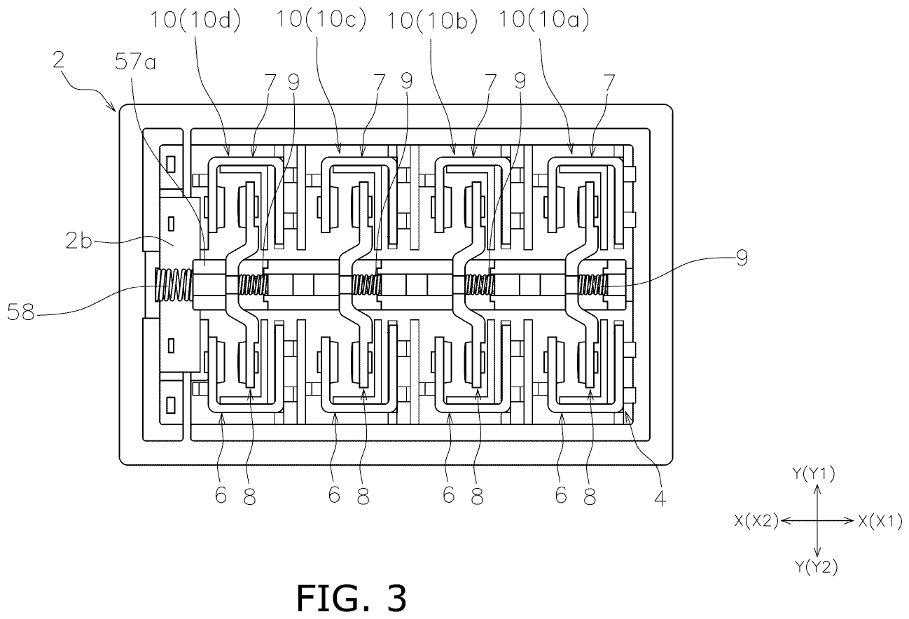

The movable contact piece 8 is configured to be movable in the left-right direction. Specifically, the movable contact piece 8 is configured to move in a contact direction in which the first movable contact 8a approaches the first fixed contact 21a, and a separation direction in which the first movable contact 8a moves away from the first fixed contact 21a. The movable contact piece 8 is movable between an open position illustrated in FIGS. 2 and 3 and a closed position illustrated in FIGS. 4 and 5. In the open position, the first movable contact 8a is separated from the first fixed contact 21a, and the second movable contact 8b is separated from the second fixed contact 31a. In the closed position, the first movable contact 8a is in contact with the first fixed contact 21a, and the second movable contact 8b is in contact with the second fixed contact 31a.

When the movable contact piece 8 is in the open position, the distance between the movable contact piece 8 and the second conductive portion 22 is greater than the distance between the first fixed contact 21a of the first conductive portion 21 and the first movable contact 8a. When the movable contact piece 8 is in the open position, the distance between the movable contact piece 8 and the third conductive portion 23 is greater than the distance between the first fixed contact 21a of the first conductive portion 21 and the first movable contact 8a.

The contact spring 9 biases the movable contact piece 8 toward the first fixed contact 21a and the second fixed contact 31a. In the present embodiment, the contact spring 9 is disposed on the right surface of the movable contact piece 8 and biases the movable contact piece 8 into the contact direction. The contact spring 9 is, for example, supported by a support protrusion (not shown) that is located on the right surface of the movable contact piece 8.

The drive device 5 is housed within the internal space defined by the partition member 3 and the case. The drive device 5 is located above the contact device 4. The drive device 5 is configured to move each of the movable contact pieces 8 of the first to fourth contact sets 10a to 10d in the left-right direction. The drive device 5 is configured to move each of the movable contact pieces 8 of the first to fourth contact sets 10a to 10d from the open position to the closed position by electromagnetic force.

As illustrated in FIGS. 1 and 2, the drive device 5 includes a coil 51, a bobbin 52, a fixed iron core 53, a yoke 54, a movable iron piece 55, a hinge spring 56, a card 57, and a return spring 58. The coil 51 is wound around the bobbin 52. The axis of the bobbin 52 extends in the left-right direction. The fixed iron core 53 is disposed within the bobbin 52. In the present embodiment, the fixed iron core 53 is formed by laminating a plurality of plate members. The yoke 54 has an L-shaped bent form. The yoke 54 is disposed above the coil 51 and to the left of the bobbin 52. The yoke 54 is connected to the left end of the fixed iron core 53.

The movable iron piece 55 is connected to the right end of the yoke 54. The movable iron piece 55 is rotatably supported on the yoke 54 via the hinge spring 56. The movable iron piece 55 rotates about the right end of the yoke 54 as a fulcrum. The movable iron piece 55 is disposed to the right of the fixed iron core 53. The movable iron piece 55 is, at the lower end thereof, connected to the card 57. The hinge spring 56 biases the movable iron piece 55 in a direction away from the fixed iron core 53.

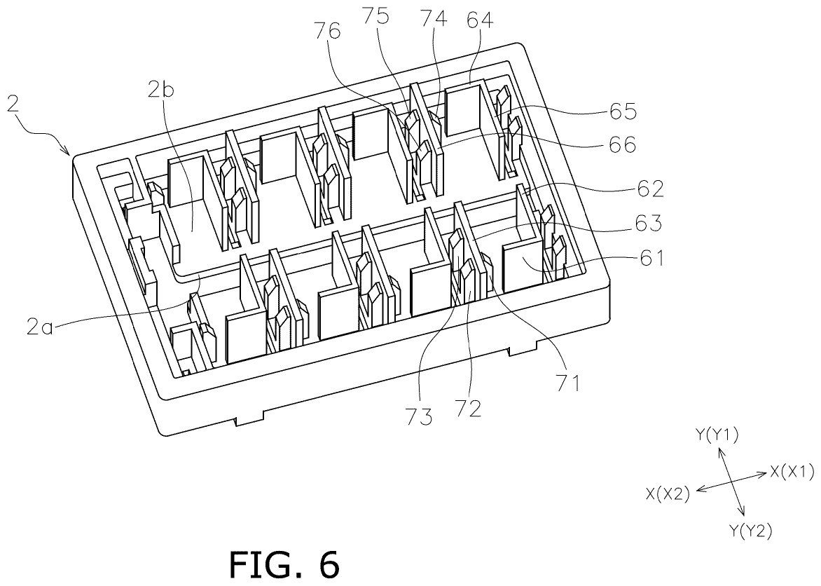

The card 57 is formed of insulating material such as resin. The card 57 is configured to move in the left-right direction as it is pressed by the movable iron piece 55 in response to the rotation of the movable iron piece 55. The card 57 is placed on the base 2, and its movement in the left-right direction is guided by a guide groove 2a of the base 2 illustrated in FIG. 6. The guide groove 2a extends in the left-right direction.

As illustrated in FIGS. 2 and 3, the card 57 includes a card body 57a, a cover 57b, and an insertion hole 57c. As illustrated in FIG. 3, the card body 57a has four spaces therein, each accommodating the movable contact piece 8 and the contact spring 9 of the respective first to fourth contact sets 10a to 10d. The four spaces are arranged side by side in the left-right direction. As illustrated in FIG. 2, the cover 57b is fixed to the upper part of the card body 57a and closes the upper sides of the four spaces. The insertion hole 57c is located in the upper right portion of the cover 57b. The insertion hole 57c is open upward to receive a part of the movable iron piece 55.

The return spring 58 is arranged at the left end of the card 57 to bias the card 57 in the separation direction.

While no voltage is applied to the coil 51, the card 57 is pressed in the separation direction by the elastic forces of the hinge spring 56 and the return spring 58, and each of the movable contact pieces 8 of the first to fourth contact sets 10a to 10d is positioned in the open position. When a voltage is applied to the coil 51, and the drive device 5 is energized, the movable iron piece 55 is attracted to the fixed iron core 53 and rotates, thereby pressing the card 57 in the contact direction. As a result, the card 57 moves in the contact direction against the elastic force of the return spring 58. Along with the movement of the card 57 in the contact direction, each of the movable contact pieces 8 of the first to fourth contact sets 10a to 10d moves to the closed position. Accordingly, in each of the first to fourth contact sets 10a to 10d, the first movable contact 8a comes into contact with the first fixed contact 21a, and the second movable contact 8b comes into contact with the second fixed contact 31a. When the application of voltage to the coil 51 is stopped, the card 57 is moved in the separation direction by the elastic forces of the hinge spring 56 and the return spring 58. As a result, each of the movable contact pieces 8 of the first to fourth contact sets 10a to 10d returns to the open position.

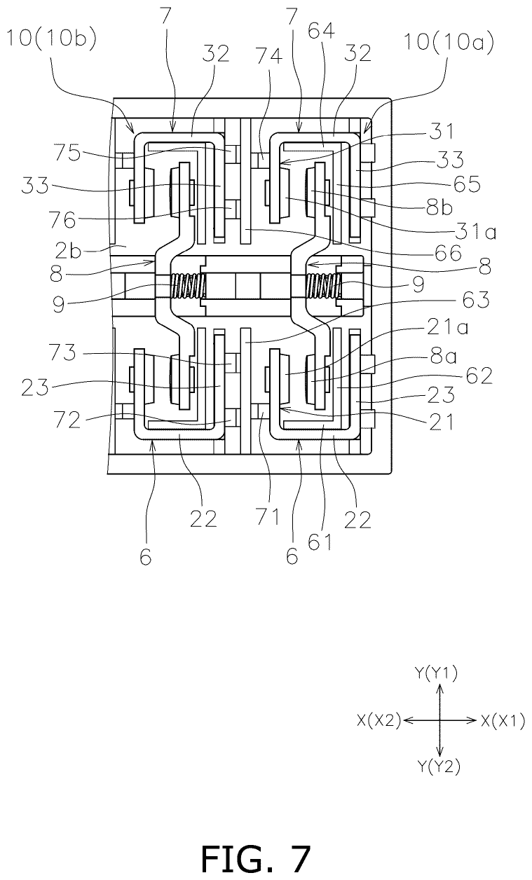

As illustrated in FIGS. 6 and 7, the electromagnetic relay 1 includes a first insulating wall 61, a second insulating wall 62, and a third insulating wall 63. In the present embodiment, the first insulating wall 61, the second insulating wall 62, and the third insulating wall 63 are integrally formed with the base 2. However, the first insulating wall 61, the second insulating wall 62, and the third insulating wall 63 may alternatively be separate members from the base 2.

The first insulating wall 61 is disposed between the movable contact piece 8 and the second conductive portion 22 of the first fixed terminal 6. The first insulating wall 61 extends in a direction intersecting the front-rear direction. The first insulating wall 61 extends upward from the bottom 2b of the base 2. The first insulating wall 61 extends above the second conductive portion 22. The first insulating wall 61 extends along the second conductive portion 22. The first insulating wall 61 is parallel to the second conductive portion 22. The first insulating wall 61 is arranged to cover the front side of the second conductive portion 22. The first insulating wall 61 is disposed laterally relative to the rear side of the movable contact piece 8.

The second insulating wall 62 is disposed between the movable contact piece 8 and the third conductive portion 23 of the first fixed terminal 6. The second insulating wall 62 extends in a direction intersecting the left-right direction. The second insulating wall 62 extends upward from the bottom 2b of the base 2. The second insulating wall 62 extends above the third conductive portion 23. The second insulating wall 62 extends along the third conductive portion 23. The second insulating wall 62 is parallel to the third conductive portion 23. The second insulating wall 62 is connected to the first insulating wall 61. When viewed from above, the second insulating wall 62 extends forward from the right end of the first insulating wall 61. The second insulating wall 62 is arranged to cover the left side of the third conductive portion 23. The second insulating wall 62 is disposed to the right of the movable contact piece 8.

The second insulating wall 62 restricts the movement of the movable contact piece 8 in the separation direction. Specifically, the second insulating wall 62 functions as a stopper to hold the movable contact piece 8 within the open position when the movable contact piece 8 returns from the closed position to the open position. The second insulating wall 62 may be in contact with the movable contact piece 8 when the movable contact piece 8 is in the open position. That is, the second insulating wall 62 may serve to position the movable contact piece 8 in the open position.

The third insulating wall 63 is disposed between the first conductive portion 21 of the first fixed terminal 6 of the first contact set 10a and the third conductive portion 23 of the first fixed terminal 6 of the second contact set 10b. The third conductive portion 23 of the first fixed terminal 6 of the second contact set 10b is arranged side by side in the left-right direction with the first conductive portion 21 of the first fixed terminal 6 of the first contact set 10a. The third conductive portion 23 of the first fixed terminal 6 of the second contact set 10b is arranged opposite the first conductive portion 21 of the first fixed terminal 6 of the first contact set 10a in the left-right direction.

The third insulating wall 63 extends in a direction intersecting the left-right direction. The third insulating wall 63 extends upward from the bottom 2b of the base 2. The third insulating wall 63 extends above both the first conductive portion 21 of the first fixed terminal 6 of the first contact set 10a and the third conductive portion 23 of the first fixed terminal 6 of the second contact set 10b.

The electromagnetic relay 1 further includes a fourth insulating wall 64, a fifth insulating wall 65, and a sixth insulating wall 66. The fourth insulating wall 64 is disposed between the movable contact piece 8 and the second conductive portion 32 of the second fixed terminal 7. The fourth insulating wall 64 is spaced apart from the first insulating wall 61 in the front-rear direction. The fourth insulating wall 64 has a shape that is symmetrical to the first insulating wall 61 in the front-rear direction. Therefore, a detailed description of the fourth insulating wall 64 is omitted.

The fifth insulating wall 65 is disposed between the movable contact piece 8 and the third conductive portion 33 of the second fixed terminal 7. The fifth insulating wall 65 is spaced apart from the second insulating wall 62 in the front-rear direction. The fifth insulating wall 65 has a shape that is symmetrical to the second insulating wall 62 in the front-rear direction. Therefore, a detailed description of the fifth insulating wall 65 is omitted.

The sixth insulating wall 66 is disposed between the first conductive portion 31 of the second fixed terminal 7 of the first contact set 10a and the third conductive portion 33 of the second fixed terminal 7 of the second contact set 10b. The sixth insulating wall 66 is spaced apart from the third insulating wall 63 in the front-rear direction. The sixth insulating wall 66 has a shape that is symmetrical to the third insulating wall 63 in the front-rear direction. Therefore, a detailed description of the sixth insulating wall 66 is omitted.

One of the first conductive portion 21 of the first fixed terminal 6 of the first contact set 10a and the third insulating wall 63 includes a first protrusion 71 configured to abut the other of the first conductive portion 21 of the first fixed terminal 6 of the first contact set 10a and the third insulating wall 63. In the present embodiment, the third insulating wall 63 includes the first protrusion 71.

The first protrusion 71 is disposed on the right surface of the third insulating wall 63. The first protrusion 71 is in contact with the left surface of the first conductive portion 21 of the first fixed terminal 6 of the first contact set 10a. The first protrusion 71 extends upward from the bottom 2b of the base 2. The upper end of the first protrusion 71 is inclined downward toward the first conductive portion 21 of the first fixed terminal 6 of the first contact set 10a. The first protrusion 71 is disposed at a position other than the caulked portion of the first fixed contact 21a of the first contact set 10a. The first protrusion 71 is situated rearward of the first fixed contact 21a of the first contact set 10a. At least a portion of the first protrusion 71 does not overlap the first fixed contact 21a of the first contact set 10a when viewed from the left-right direction. The first conductive portion 21 of the first fixed terminal 6 of the first contact set 10a is positioned by the first protrusion 71.

One of the third conductive portion 23 of the first fixed terminal 6 of the second contact set 10b and the third insulating wall 63 includes second protrusions 72 and 73 configured to abut the other of the third conductive portion 23 of the first fixed terminal 6 of the second contact set 10b and the third insulating wall 63. In the present embodiment, the third insulating wall 63 includes the second protrusions 72 and 73.

The second protrusions 72 and 73 are located on the left surface of the third insulating wall 63. The second protrusions 72 and 73 are in contact with the right surface of the third conductive portion 23 of the first fixed terminal 6 of the second contact set 10b. The second protrusions 72 and 73 extend upward from the bottom 2b of the base 2. The upper ends of the second protrusions 72 and 73 are inclined downward toward the third conductive portion 23 of the first fixed terminal 6 of the second contact set 10b. The second protrusion 72 is spaced apart from the second protrusion 73 in the left-right direction. When viewed from the left-right direction, the second protrusion 72 overlaps the first protrusion 71. The third conductive portion 23 of the first fixed terminal 6 of the second contact set 10b is positioned by the second protrusions 72 and 73.

The sixth insulating wall 66 includes a third protrusion 74 and fourth protrusions 75 and 76. The third protrusion 74 has a shape that is symmetrical to the first protrusion 71 in the front-rear direction. The fourth protrusions 75 and 76 have a shape that is symmetrical to the second protrusions 72 and 73 in the front-rear direction.

As illustrated in FIGS. 2, 3, and 6, structures similar to those of the first insulating wall 61, the second insulating wall 62, the fourth insulating wall 64, and the fifth insulating wall 65 are arranged in each of the spaces that accommodate the second contact set 10b, the third contact set 10c, and the fourth contact set 10d. As also illustrated in FIGS. 2, 3, and 6, structures similar to those of the third insulating wall 63 and the sixth insulating wall 66 are arranged respectively between the second contact set 10b and the third contact set 10c and between the third contact set 10c and the fourth contact set 10d.

In FIGS. 4 and 5, an example of the current path through the first fixed terminal 6, the second fixed terminal 7, and the movable contact piece 8 during energization is schematically indicated by dashed arrows. In this example, current flows in the order of the first fixed terminal 6, the movable contact piece 8, and the second fixed terminal 7. In the first fixed terminal 6, current flows in the order of the fourth conductive portion 24, the third conductive portion 23, the second conductive portion 22, and the first conductive portion 21. In the movable contact piece 8, current flows in the direction from the first movable contact 8a to the second movable contact 8b. In the second fixed terminal 7, current flows in the order of the first conductive portion 31, the second conductive portion 32, the third conductive portion 33, and the fourth conductive portion 34.

As illustrated in FIG. 5, a magnetic field is generated by a current C1 flowing through the second conductive portion 22 of the first fixed terminal 6 and acts on a current C2 flowing through the movable contact piece 8. As a result, a first Lorentz force F1 is generated. The first Lorentz force F1 acts on the movable contact piece 8 in the contact direction. Furthermore, another magnetic field is generated by a current C3 flowing through the third conductive portion 23 of the first fixed terminal 6 and acts on the current C2 flowing through the movable contact piece 8. As a result, a second Lorentz force F2 is generated. The second Lorentz force F2 also acts on the movable contact piece 8 in the contact direction. The first Lorentz force F1 and the second Lorentz force F2 act in a direction opposite to the electromagnetic repulsive force generated between the first fixed contact 21a and the first movable contact 8a. Accordingly, the electromagnetic repulsive force can be decreased. With this configuration, for example, compared to a case in which the electromagnetic force of the drive device 5 is increased to reduce the separation between the first fixed contact 21a and the first movable contact 8a, it is possible to restrain an increase in the size of the electromagnetic relay 1.

In addition, a magnetic field is generated by a current C4 flowing through the second conductive portion 32 of the second fixed terminal 7, and another magnetic field is generated by a current C5 flowing through the third conductive portion 33. These magnetic fields act on the current C2 flowing through the movable contact piece 8. As a result, a third Lorentz force F3 and a fourth Lorentz force F4 are generated, which act in the direction opposite to the electromagnetic repulsive force generated between the second fixed contact 31a and the second movable contact 8b. The first Lorentz force F3 and the second Lorentz force F4 act in a direction opposite to the electromagnetic repulsive force between the second fixed contact 31a and the second movable contact 8b. Therefore, the electromagnetic repulsive force can be decreased.

One embodiment of the electromagnetic relay according to one aspect of the claimed invention has been described above. The claimed invention, however, is not limited to the above embodiment, and various changes can be made without departing from the scope of the claimed invention.

The number of the contact sets 10 may vary; two or more contact sets 10 are sufficient. The movable contact piece 8 may extend in a straight line. The thickness of the first fixed terminal 6 does not need to be uniform. For example, the third conductive portion 23 and the fourth conductive portion 24 may be subjected to hemming. The first to fourth conductive portions 21 to 24 are each formed by bending a single plate terminal in the present embodiment; however, they may also be formed as separate members and then joined together. The second conductive portion 22 may be R-shaped.

The first conductive portion 21 of the first fixed terminal 6 of the first contact set 10a may include the first protrusion 71. That is, the first protrusion 71 may instead be formed on the first conductive portion 21 of the first fixed terminal 6 of the first contact set 10a. The third conductive portion 23 of the first fixed terminal 6 of the second contact set 10b may include the second protrusions 72 and 73. That is, the second protrusions 72 and 73 may be located on the third conductive portion 23 of the first fixed terminal 6 of the second contact set 10b. One of the second protrusions 72 and 73 may be omitted.

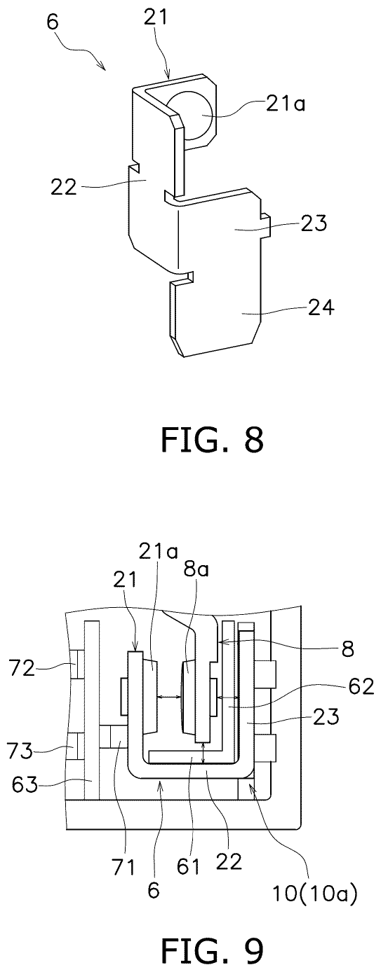

The third conductive portions 23 and 33 may have a notched shape. As illustrated in FIG. 8, the third conductive portion 23 of the first fixed terminal 6 may not overlap the first fixed contact 21a when viewed from the left-right direction. The third conductive portion 23 of the first fixed terminal 6 may also not overlap the first conductive portion 21 when viewed from the left-right direction. Similarly, the third conductive portion 33 of the second fixed terminal 7 may not overlap the second fixed contact 31a when viewed from the left-right direction.

As illustrated in FIG. 9, when the movable contact piece 8 is in the open position, the distance between the movable contact piece 8 and the second conductive portion 22 may be equal to or less than the distance between the first fixed contact 21a of the first conductive portion 21 and the first movable contact 8a. When the movable contact piece 8 is in the open position, the distance between the movable contact piece 8 and the second conductive portion 22 may also be smaller than the distance between the first fixed contact 21a of the first conductive portion 21 and the first movable contact 8a. Similarly, when the movable contact piece 8 is in the open position, the distance between the movable contact piece 8 and the third conductive portion 23 may be equal to or less than the distance between the first fixed contact 21a of the first conductive portion 21 and the first movable contact 8a. Furthermore, the distance between the movable contact piece 8 and the third conductive portion 23 may also be smaller than the distance between the first fixed contact 21a and the first movable contact 8a when the movable contact piece 8 is in the open position.

### REFERENCE NUMERALS

1: Electromagnetic relay, 6: First fixed terminal, 7: Second fixed terminal, 8: Movable contact piece, 8a: First movable contact, 8b: Second movable contact, 10: A plurality of contact sets, 10a: First contact set, 10b: Second contact set, 21: First conductive portion, 21a: First fixed contact, 22: Second conductive portion, 23: Third conductive portion, 24: Fourth conductive portion, 61: First insulating wall, 62: Second insulating wall, 63: Third insulating wall, 71: First protrusion, 72, 73: Second protrusion

What is claimed is:

1. An electromagnetic relay, comprising:
a contact device including a plurality of contact sets, each of the plurality of contact sets including a first fixed terminal, a second fixed terminal, and a movable contact piece, the first fixed terminal including a first fixed contact, the second fixed terminal including a second fixed contact spaced apart from the first fixed contact in a first direction, the movable contact piece including a first movable contact and a second movable contact, the first movable contact facing the first fixed contact in a second direction orthogonal to the first direction, the second movable contact facing the second fixed contact in the second direction, the plurality of contact sets being arranged in the second direction; and
a drive device configured to move the movable contact pieces of the plurality of contact sets in the second direction;
wherein the first fixed terminal includes:
a first conductive portion including the first fixed contact;
a second conductive portion connected to the first conductive portion, the second conductive portion arranged, at least in part, laterally relative to the movable contact piece in the first direction; and
a third conductive portion connected to the second conductive portion, the third conductive portion extending in a direction from the first movable contact toward the second movable contact.

2. The electromagnetic relay according to claim 1, further comprising:
a base for positioning the first fixed terminal; and
the first fixed terminal further includes a fourth conductive portion extending from the third conductive portion in a third direction orthogonal to both the first direction and the second direction, the fourth conductive portion protruding from the base in the third direction.

3. The electromagnetic relay according to claim 1, wherein
the third conductive portion overlaps the first fixed contact when viewed from the second direction.

4. The electromagnetic relay according to claim 1, wherein
the second conductive portion overlaps the center of the first movable contact in a state where the first movable contact is in contact with the first fixed contact.

5. The electromagnetic relay according to claim 1, further comprising:
a first insulating wall disposed between the movable contact piece and the second conductive portion.

6. The electromagnetic relay according to claim 5, wherein
a distance between the movable contact piece and the second conductive portion is equal to or less than a distance between the first movable contact and the first conductive portion, in a state where the first movable contact is separated from the first conductive portion.

7. The electromagnetic relay according to claim 1, further comprising:
a second insulating wall disposed between the movable contact piece and the third conductive portion.

8. The electromagnetic relay according to claim 7, wherein
a distance between the movable contact piece and the third conductive portion is equal to or less than a distance between the first movable contact and the first conductive portion, in a state where the first movable contact is separated from the first conductive portion.

9. The electromagnetic relay according to claim 7, wherein
the second insulating wall restricts a movement of the movable contact piece in a direction in which the first movable contact separates from the first fixed contact.

10. The electromagnetic relay according to claim 1, further comprising:
a third insulating wall, wherein
the plurality of contact sets includes a first contact set and a second contact set adjacent to the first contact set, and
the third insulating wall is disposed between the first conductive portion of the first fixed terminal of the first contact set and the third conductive portion of the first fixed terminal of the second contact set.

11. The electromagnetic relay according to claim 10, wherein
one of the first conductive portion of the first fixed terminal of the first contact set and the third insulating wall includes a first protrusion configured to abut another of the first conductive portion of the first fixed terminal of the first contact set and the third insulating wall.

12. The electromagnetic relay according to claim 10, wherein
one of the third conductive portion of the first fixed terminal of the second contact set and the third insulating wall includes a second protrusion configured to abut another of the third conductive portion of the first fixed terminal of the second contact set and the third insulating wall.

13. The electromagnetic relay according to claim 1, wherein
a distance between the movable contact piece and the second conductive portion is greater than a distance between the first movable contact and the first conductive portion, in a state where the first movable contact is separated from the first conductive portion, and
a distance between the movable contact piece and the third conductive portion is greater than the distance between the first movable contact and the first conductive portion, in the state where the first movable contact is separated from the first conductive portion.

14. The electromagnetic relay according to claim 1, wherein
the third conductive portion does not overlap the first fixed contact when viewed from the second direction.
